(19) United States
(12) Patent Application Publication
(10) Pub. No.: US 2010/0039809 A1
(43) Pub. Date: Feb. 18, 2010

(54) SIMULATING APPARATUS OF FACIAL EXPRESSION AND COMPUTER PERIPHERAL

(75) Inventors: Jung Ying Yao, Taoyuan (TW); Yu Hua Kan, Taoyuan (TW); Jung Chi Lai, Taoyuan (TW); Chin Jung Su, Taoyuan (TW); Chien Hsin Lee, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/539,815

(22) Filed: Aug. 12, 2009

(30) Foreign Application Priority Data
Aug. 14, 2008 (TW) 097214576

(51) Int. Cl. F21V 1/00

(52) U.S. Cl. 362/235

(57) ABSTRACT

The invention discloses a simulating apparatus of facial expression comprising a casing and a facial expression module, wherein the casing has a transparent surface, and the facial expression module is configured in the casing and behind the transparent surface. The facial expression module comprises a plurality of light guiding components, a plurality of light sources, and a control module. The lighting guiding devices is used for making up a plurality of facial patterns; the light sources are configured at one side of the light guiding components, and the light, emitted by the light sources, can be transmitted through the light guiding components to bring the facial patterns a lighting effect; the control module is electrically connected to the light sources for selectively controlling the light sources to emit light.

### BACKGROUND OF THE INVENTION

1. Field of the Invention

The present invention relates generally to a simulating apparatus of facial expression and a computer peripheral comprising the same, and more particularly, to a simulating apparatus of facial expression with light guiding components and a computer peripheral comprising the same.

2. Description of the Prior Art

With rapid development of electric and information industries and neuron networks, certain intelligent electronic apparatus with simulation behavior, such as robot or electronic pets, are presented to the market. Said intelligent products apply artificial intelligence to simulate creature's response to sound or light. For example, some of the products can act or display facial expressions in response to sound or light.

In the prior art, the intelligent products can change different facial expressions by motors and sets of gears. In practice, the motors can receive control signal to drive the gears to move eyebrow components, mouth component or other components to perform different facial expressions. Additionally, in the prior art, a certain of light-emitting units can be disposed in the face portion of said intelligent products, and each of the light-emitting units can be applied as a basic point to display facial expressions. That is, the intelligent products can control the light-emitting units selectively lighting to display different facial expressions.

However, the way for displaying facial expressions by motors and gears may cause abrasion of the gears and reduce the lifetime of said elements. Moreover, the way for displaying facial expressions by lighting needs a large amount of light-emitting units, such that the cost for producing related products will be increased.

Additionally, because the required volume of the motors and the gears and the required number of the light-emitting units are large, the size of products contain said elements is hard to reduced.

### SUMMARY OF THE INVENTION

Accordingly, a scope of the present invention is to provide a simulating apparatus of facial expression for displaying different facial expressions by light guiding components to solve the above-mentioned problem.

According to an embodiment, the simulating apparatus of facial expression includes a casing and a facial expression module. The casing has a transparent surface, and the facial expression module is configured in the casing and behind the transparent surface. The facial expression module further includes a plurality of light guiding components, a plurality of light sources and at least one control module.

In the embodiment, the control module is electrically connected to the light sources for selectively controlling the light sources to emit light. The light emitted by the light sources transmitted through the light guiding components to bring the facial patterns a lighting effect. The light guiding components can be arranged to form several kinds of facial expressions. Moreover, by using the control module to selectively drive different light sources to emit light, the light guiding components correspond to the light sources receive and transmit the light to display facial patterns with lighting effect. Accordingly, users can observe the facial patterns through the transparent surface of the casing.

Another scope of the invention is to provide a computer peripheral for receiving a changing command and for displaying different facial expressions by using light guiding components according to the changing command to solve the above-mentioned problem.

According to an embodiment, the computer peripheral of the invention includes a receiving module, a casing and a facial expression module. The receiving module is applied for receiving a changing command. The casing has a transparent surface, and the facial expression module is configured in the casing and behind the transparent surface. The facial expression module further includes a plurality of light guiding components, a plurality of light sources and at least one control module.

In the embodiment, the control module is electrically connected to the light sources for selectively controlling the light sources to emit light according to the changing command. The light emitted by the light sources transmitted through the light guiding components to bring the facial patterns a lighting effect. The light guiding components can be arranged to form several kinds of facial expressions. Moreover, by using the control module to selectively drive different light sources to emit light, the light guiding components correspond to the light sources receive and transmit the light to display facial patterns with lighting effect. Accordingly, users can observe the facial patterns through the transparent surface of the casing.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a facial expression module 1 of an embodiment of the invention.

FIG. 2 shows a sectional view of a simulating apparatus 2 of facial expression of an embodiment of the invention.

FIG. 3 illustrates a simulating apparatus 3 of facial expression of an embodiment of the invention.

FIG. 4A to FIG. 4E illustrate the operation of the simulating apparatus 3 of facial expression in FIG. 3.

FIG. 5 illustrates a simulating apparatus 4 of facial expression of an embodiment of the invention.

FIGS. 6A and 6B illustrate the operation of the simulating apparatus 4 of facial expression in FIG. 5.

### DETAILED DESCRIPTION OF THE INVENTION

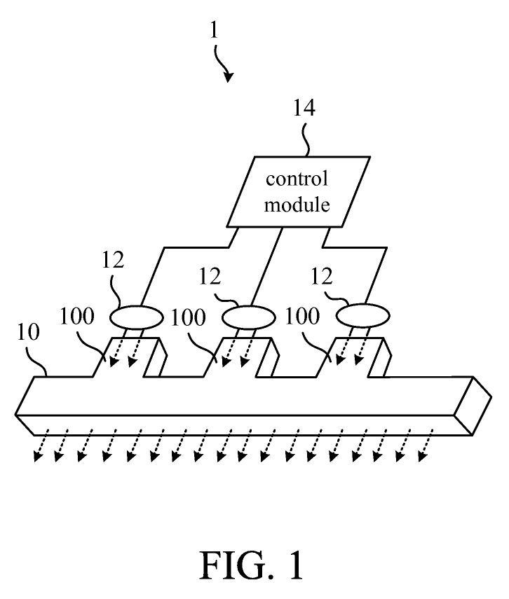

Please refer to FIG. 1, which illustrates a facial expression module 1 of an embodiment of the invention. In practice, the facial expression module 1 can be configured in a casing with a transparent surface to form a simulating apparatus of facial expression for an intelligent electronic apparatus. As shown in FIG. 1, the facial expression module 1 of the invention further includes light guiding components 10, light sources 12 and a control module 14.

In the embodiment, the light guiding components 10 includes at least a light guiding columns 100 adjacent to the light sources 12. The control module 14 can be electrically connected to the light sources 12 to control the light sources 12 to emit light, and the light can be transmitted to the light guiding components 10 through the light guiding columns 100 to bring the facial patterns a lighting effect. Please note that, in practice, the light sources 12 can be, but not limited to light-emitting diodes. Moreover, in the embodiment, the light guiding components 10 have three light guiding columns 100 to cooperate with three light sources 12. However, in practice, the number of the light guiding columns 100 and the light sources 12 can be changed according to the requirement of users or designers. For example, longer light guiding component or light guiding component with less light conductivity needs more light guiding columns and/ or light sources to provide sufficient light effect.

The control module 14 can be use to control the light sources 12 to emit light, in practice, users can control the timing for the light guiding components 10 to have the lighting effect by the control module 14.

According to another embodiment, the facial expression module of the invention includes sets of the above-mentioned light guiding components and light sources. Similarly, each light guiding component has at least one light guiding column corresponds to each light source. For example, the facial expression module can include two light guiding components, one has three light guiding columns correspond to three light sources, and the other one has four light guiding columns correspond to four light sources. As mentioned above, the control module can selectively control these light sources to make said two light guiding components perform different light effect.

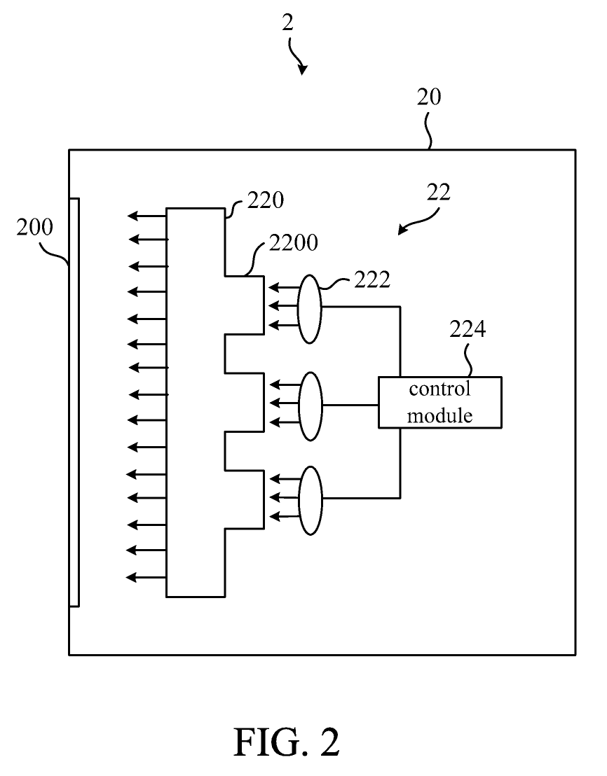

Please refer to FIG. 2, which shows a sectional view of a simulating apparatus 2 of facial expression of an embodiment of the invention. As shown in FIG. 2, the simulating apparatus 2 of facial expression includes a casing 20 and a facial expression module 22, wherein the casing 20 further includes a transparent surface 200. Accordingly, users can observe the light emitted from inner of the casing 20 via the transparent surface 200. Please note that, in practice, the shape of the casing 20, the shape of the transparent surface 200 and the location of the transparent surface 200 can be optionally changed but not limited to the examples of the embodiments.

In the embodiment, the facial expression module 22 includes a light guiding component 220 adjacent to the transparent surface 200. Moreover, one side of the light guiding component 220 opposite to the transparent surface 200 formed with a plurality of light guiding columns 2200. Additionally, the facial expression module 22 further includes a plurality of light sources 222 and a control module 224. Each of the light sources 222 is adjacent to one of the light guiding columns 2200, and the control module 224 is electrically connected to each of the light sources 222 for selectively control the light sources 222 to emit light. The emitted light is sent to the transparent surface 200 through the light guiding columns 2200 and the light guiding component 220. Accordingly, users can observe the light effect performed by the light guiding component 220 via the transparent surface 200.

Please note that, in practice, the control module can control all the light sources correspond to a certain light guiding component to light at the same time, such that the light guiding component can maintain the light effect. Moreover, by different light effects of the light guiding components, users can observe facial patterns correspond to different facial expressions.

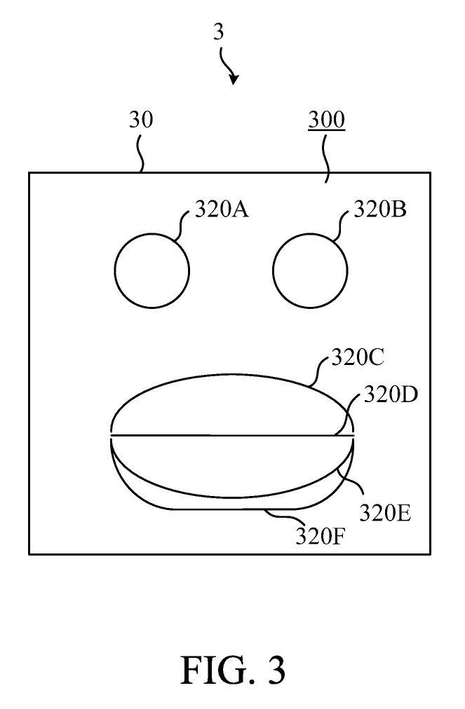

Please refer to FIG. 3, which illustrates a simulating apparatus 3 of facial expression of an embodiment of the invention. As shown in FIG. 3, the simulating apparatus 3 of facial expression includes a casing 30 which includes a transparent surface 300.

In the embodiment, the simulating apparatus 3 of facial expression further includes a plurality of light guiding components 320A, 320B, 320C, 320D, 320E and 320F. The light guiding components 320A and 320B are arranged as a circle to represent the pattern of eyes, and the light guiding components 320C to 320F are arranged to represent the pattern of mouth. As mentioned above, the number, arrangement and shape of the light guiding components can be changed according to the requirements of users or designers, but not limited to the embodiment.

In the embodiment, the structure of each of the light guiding components 320A to 320F is the same as mentioned in the last embodiment. That is, each of the light guiding components 320A to 320F has a plurality of light guiding columns (not shown) and a plurality of light sources (not shown). Moreover, the facial expression module of the embodiment can further includes a control module (not shown) for selectively controlling the light sources to light, such that each of the light guiding components 320A to 320F can selectively perform light effects.

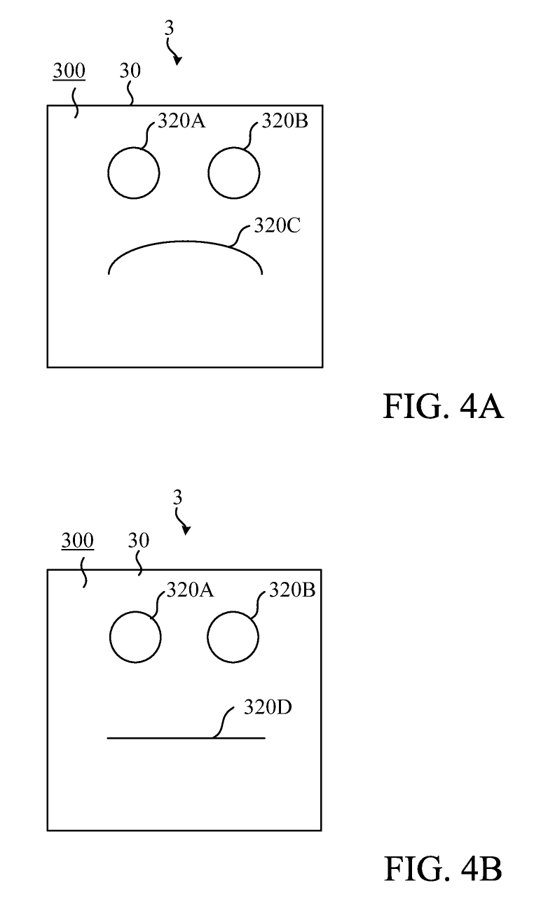

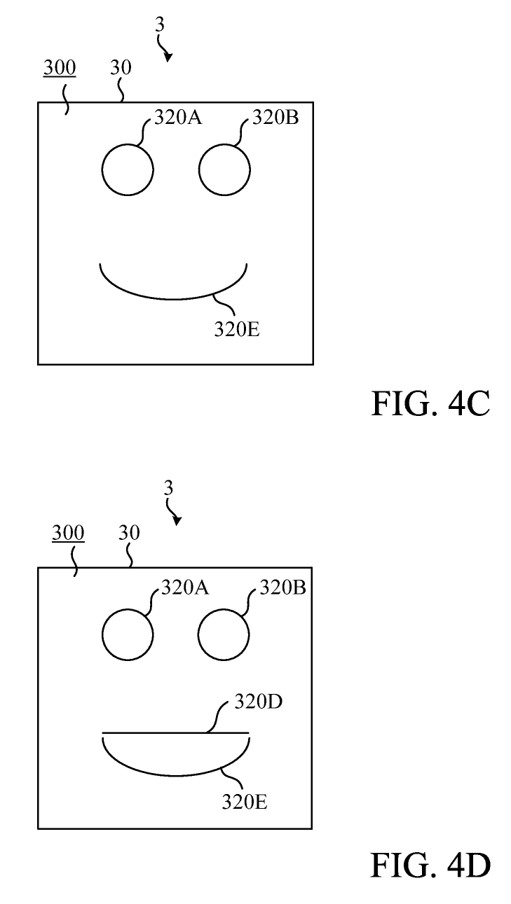

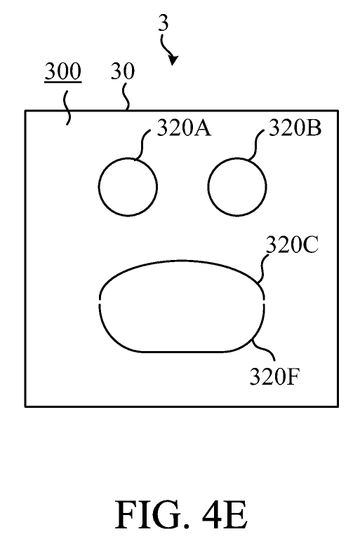

Accordingly, users can observe different facial patterns through the transparent surface 300 when the above-mentioned light guiding components 320A to 320F selectively perform different light effects. Please further refer to FIG. 4A to FIG. 4E, which illustrate the operation of the simulating apparatus 3 of facial expression in FIG. 3.

As shown in FIG. 4A, the control module controls the light sources correspond to the light guiding components 320A, 320B and 320C to emit light and cause said three light guiding components 320A, 320B and 320C perform light effects. Accordingly, users can observe a facial pattern represents anger through the transparent surface 300.

As shown in FIG. 4B, the control module controls the light guiding components 320A, 320B and 320D to perform light effects. Accordingly, users can observe a facial pattern represents calmness through the transparent surface 300.

As shown in FIG. 4C, the control module controls the light guiding components 320A, 320B and 320E to perform light effects. Accordingly, users can observe a facial pattern represents smile through the transparent surface 300.

As shown in FIG. 4D, the control module controls the light guiding components 320A, 320B, 320D and 320E to perform light effects. Accordingly, users can observe a joyful face through the transparent surface 300.

As shown in FIG. 4E, the control module controls the light guiding components 320A, 320B, 320C and 320F to perform light effects. Accordingly, users can observe an amazed face through the transparent surface 300.

As mentioned above, the light guiding components correspond to the light sources receive and transmit the light to display facial patterns with lighting effect. Accordingly, users can observe the facial patterns through the transparent surface of the casing.

In the above-mentioned examples, light guiding components 320A and 320B continuously perform light effect. However, in practice, we can apply several light guiding components to represent the pattern of eyes, so as to display different eye patterns.

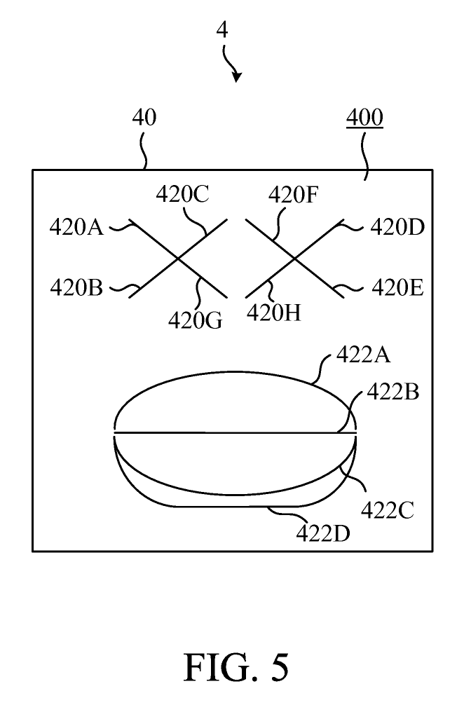

Please refer to FIG. 5, which illustrates a simulating apparatus 4 of facial expression of an embodiment of the invention. As shown in FIG. 5, the simulating apparatus 4 of facial expression includes a casing 40 which includes a transparent surface 400.

As shown in FIG. 5, the simulating apparatus 4 of facial expression of the embodiment includes six light guiding components 420A to 420F arranged to represent the pattern of eyes, and four light guiding components 422A to 422D arranged to represent the pattern of mouth.

In the embodiment, the structure of each of the light guiding components is the same as the last embodiment. Each of the light guiding components includes a plurality of light guiding columns (not shown) adjacent to a plurality of light sources (not shown). Moreover, the facial expression module of the embodiment can further includes a control module (not shown) for selectively controlling the light sources to light, such that each of the light guiding components 420A to 420H and 422A to 422D can selectively perform light effects.

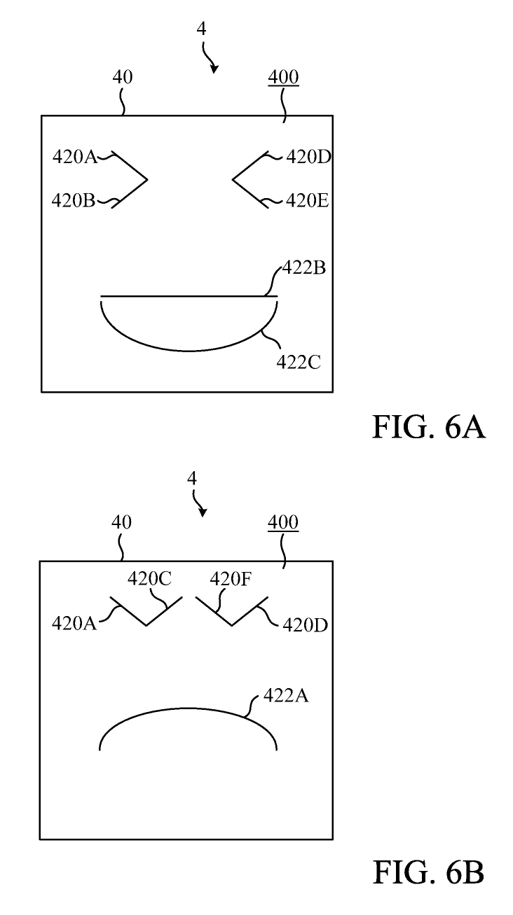

Please further refer to FIGS. 6A and 6B, which illustrate the operation of the simulating apparatus 4 of facial expression in FIG. 5. As shown in FIG. 6A, the control module controls the light guiding components 420A, 420B, 420D, 420E, 422B and 422C to perform light effects. Accordingly, users can observe a very joyful face through the transparent surface 300.

As shown in FIG. 6B, the control module controls the light guiding components 420A, 420C, 420D, 420F and 422A to perform light effects. Accordingly, users can observe an unhappy face through the transparent surface 300.

As described above, light guiding components with different light effects can display different facial patterns. In practice, the light guiding components can also be arranged to represent the pattern of nose, ears or other parts of the face.

According to another embodiment, the computer peripheral of the invention includes the above-mentioned simulating apparatus of facial expression and receiving module. Similarly, the above-mentioned simulating apparatus of facial expression of the embodiment includes a casing with a transparent surface and a facial expression module configured within the casing. The control module of the facial expression module can selectively control the light sources of the facial expression module to light, and the light makes the light guiding components performing a light effect to form different facial patterns. Accordingly, users can observe facial patterns with light effect via the transparent surface of the casing.

In the embodiment, the receiving module is used for receiving a changing command and sending the changing command to the control module, such that the control module can control different light sources to light to make the light guiding components making up different facial patterns. In practice, the changing command can be inputted by users or by artificial intelligence system. For example, the artificial intelligence system of robot can response to the command inputted by users and generate correspond change command to the receiving module. In practice, the changing command represents angry, happy, sad and other emotions, and the simulating apparatus of facial expression can display such emotions according to the changing command.

To sum up, the simulating apparatus of facial expression of the invention applies control module to selectively control light sources to light, and cause light effect of the light guiding components to display different facial patterns. Because the simulating apparatus of the invention does not apply mechanical elements, the lifetime of the apparatus will not be reduced by mechanical behavior. Moreover, the simulating apparatus of facial expression of the invention can use light-emitting diodes to be the light sources, so as to elongate the lifetime of the apparatus. Particularly, because the light guiding components of the invention can guide light to pre-determined location to form the desired facial patterns, the simulating apparatus does not require too many lighting units. Therefore, both of the cost and size of the simulating apparatus of the invention can be reduced.

Although the present invention has been illustrated and described with reference to the preferred embodiment thereof, it should be understood that it is in no way limited to the details of such embodiment but is capable of numerous modifications within the scope of the appended claims.

What is claimed is:

1. A simulating apparatus of facial expression comprising:
a casing having a transparent surface; and
a facial expression module configured in the casing and behind the transparent surface, and the facial expression module comprising:
a plurality of light guiding components for making up a plurality of facial patterns;
a plurality of light sources configured at one side of the light guiding components, and the light emitted by the light sources transmitted through the light guiding components to bring the facial patterns a lighting effect; and
a control module electrically connected to the light sources for selectively controlling the light sources to emit light.

2. The simulating apparatus of claim 1, wherein the light guiding components comprise a plurality of light guiding columns.

3. The simulating apparatus of claim 1, wherein the light sources comprise at least a light-emitting diode.

4. The simulating apparatus of claim 1, wherein the facial patterns comprise an eyes pattern or a mouth pattern.

5. A computer peripheral comprising:
a receiving module for receiving a changing command;
a casing having a transparent surface; and
a facial expression module configured in the casing and behind the transparent surface, and the facial expression module comprising:
a plurality of light guiding components for making up a plurality of facial patterns;
a plurality of light sources configured at one side of the light guiding components, and the light emitted by the light sources transmitted through the light guiding components to bring the facial patterns a lighting effect; and
a control module electrically connected to the light sources for selectively controlling the light sources to emit light according to the changing command.

6. The computer peripheral of claim 5, wherein the light guiding components comprise a plurality of light guiding columns.

7. The computer peripheral of claim 5, wherein the light sources comprise at least a light-emitting diode.

8. The computer peripheral of claim 5, wherein the facial patterns comprise an eyes pattern or a mouth pattern.
